(19) United States
(12) Patent Application Publication
(10) Pub. No.: US 2012/0205363 A1
(43) Pub. Date: Aug. 16, 2012

(54) CANNED PRODUCT HEATING APPARATUS

(75) Inventors: Tetsuya Takatomi, Sagamihara-Shi (JP); Shigeki Matsuura, Ibaraki-shi (JP); Taichi Ijuin, Sagamihara-shi (JP); Tomio Yamauchi, Sagamihara-shi (JP)

(73) Assignee: DAIWA CAN COMPANY, Tokyo (JP)

(21) Appl. No.: 13/383,043

(22) PCT Filed: Jan. 18, 2010
(86) PCT No.: PCT/JP10/50477

§ 371 Date: Jan. 9, 2012

(30) Foreign Application Priority Data
Jul. 22, 2009 (JP) 2009-171535

(51) Int. Cl. B23K 13/08

(52) U.S. Cl. 219/482

(57) ABSTRACT

A canned product heating apparatus includes: a non-contact type temperature detecting element which is not in contact with a surface of a can container; a directional microphone oriented to a closure of the can container; an interrupting circuit which interrupts an electrical supply to a high-frequency induction heating coil based on a signal transmitted from the directional microphone. The electrical supply to the high-frequency induction heating coil is stopped by the interrupting circuit in case the directional microphone captures sonic waves within a predetermined range.

### TECHNICAL FIELD

The present invention relates to a canned product heating apparatus, and more specifically, to an apparatus for heating a canned product when a consumer purchases the canned product.

### BACKGROUND ART

In recent years, canned products being stored at a low temperature or room temperature are heated to a drinkable temperature when purchased by a consumer. In case of thus heating canned products at the time of sale, the canned products are not necessary to be heated during storage so that electrical cost can be saved. In addition to the above-explained advantage, content of the canned product will not be exposed to high temperatures for long time during storage so that the content of the canned product can be prevented from being deteriorated in its flavor.

For example, Japanese Patent Publication No. 57-16394 discloses a can heater of automatic vending machines which is provided with: a high-frequency induction heating coil for heating the canned products inductively; a temperature detecting element for detecting a surface temperature of the canned product; a temperature detecting circuit for controlling electric power supply to the high-frequency induction heating coil in accordance with the temperature detected by the temperature detecting element; and a temperature indicator for indicating the temperature detected by the temperature detecting element.

Specifically, according to the teachings of Japanese Patent Publication No. 57-16694, a contact-type temperature detecting element having a terminal which is to be contacted to the surface of the canned product is used in the can heater. However, in case of detecting a temperature of a canned product having different diameter, or in case the caned product to be heated is not positioned accurately at a heating position, the above-explained contact-type temperature detecting element will not be contacted properly with the surface of the canned product. In this case, an air temperature around the canned product will be detected instead of the surface temperature of the canned product. Actually, the air temperature around the canned product is lower than the surface temperature of the canned product. If the temperature of the canned product is controlled on the basis of the detected air temperature around the canned product, the canned product may be heated excessively. In case the temperature of the canned product is raised excessively, a can lid may be expanded by an internal pressure of the canned product raised by such a temperature rise, and this may cause an explosion of the canned product.

In order to heat the contents of the canned product homogeneously, the canned product being heated may be oscillated together with the high frequency inductive heating coil. For this purpose, in the heating apparatus using the above-explained contact-type temperature detecting element, the detecting element has to be kept in contact with the surface of the canned product being heated while being oscillated by oscillating the detecting element together with the canned product. However, in case of thus oscillating the temperature detecting element, it is difficult to keep a terminal thereof being contacted properly with the surface of the canned product.

Therefore, in order to detect the surface temperature of the canned product, it is preferable to use a noncontact type temperature detecting element configured to detect the temperature of the canned product without contacting the terminal thereof to the surface of the canned product. However, a temperature detecting accuracy of the noncontact type temperature detecting element is degraded depending on a detecting condition such as an irregularity in the surface of the canned product, or change in a positional relation between the temperature detecting element and the canned product resulting from the oscillation of the canned product. Specifically, the noncontact type temperature detecting element has a margin of error of approximately plus or minus 6 degrees C.

Thus, as in case of using the contact-type temperature detecting element, the temperature detecting error has to be caused even in case of using the noncontact-type temperature detecting element to detect the surface temperature of the canned product being oscillated. Therefore, in case the surface temperature of the canned product is detected approximately 6 degrees C. lower than the actual temperature, for example, the temperature of the heat for heating the canned product would be controlled based on the temperature thus detected erroneously which is lower than the actual surface temperature. Consequently, the surface temperature of the canned product is inevitably overheated as is the case of using the contact-type temperature detecting element. As a result, the can lid is expanded outwardly and this may cause an explosion of the canned product.

### DISCLOSURE OF THE INVENTION

The present invention has been conceived noting the technical problems thus far described. Therefore, an object of the present invention is to provide a canned product heating apparatus for heating a canned product when a consumer purchases the canned product being stored, which is capable of heating the canned product safely while detecting a temperature of the canned product using a temperature detecting element, without causing deformation or explosion of the canned product resulting from overheat.

In order to achieve-mentioned object, according to the present invention, there is provided a canned product heating apparatus, comprising: a heating means, which is adapted to heat a content of a canned product by heating a surface of the canned product sealed by a closure; a temperature detecting element, which is adapted to detect a temperature of the surface of the canned product; and a control means, which is adapted to control the heating means to carry out a heating and to stop the heating in accordance with the temperature detected by the temperature detecting element. The canned product heating apparatus of the present invention is characterized by further comprising a detecting means adapted to detect vibrations of the closure during the heating of the canned product. In addition, the control means includes a means adapted to stop the heating means to heat the canned product, in case the detecting means detects particular vibrations of the closure resulting from temperature rise of the surface of the canned product.

According to the present invention, the temperature detecting element is adapted to detect the temperature of the surface of the canned product without being contacted thereto; the heating means includes a high-frequency induction heating coil; the detecting means includes a directional microphone; and the control means includes an interrupting circuit which is adapted to interrupt electrical power distribution to the high-frequency induction heating coil.

In addition, the aforementioned particular vibrations include sonic waves within a predetermined frequency range resulting from a deformation of the closure.

That is, the surface temperature of the canned product detected by the temperature detecting element may be lower than the actual surface temperature thereof, and the canned product is therefore further heated even after the temperature of the contents is raised to the desired drinkable temperature. As a result, an internal pressure of the can is raised and the closure is thereby elastically deformed slightly outwardly. When the closure is thus deformed elastically, the closure is vibrated within a particular frequency range while generating a vibration noise. Such noise or vibrations is/are detected by the directional microphone as the detecting means, and the interrupting circuit as the control means brings the high-frequency induction heating coil as the heating means to stop heating the canned product on the basis of a detection signal. Thus, according to the present invention, even though the temperature detecting element has a margin of detection error, the heating of the canned product is stopped before the canned product is heated excessively. Therefore, the closure is deformed elastically only to the extent possible to be returned to the original shape, that is, the closure can be prevented from being deformed plastically and from being exploded.

As described, according to the present invention, the noncontact-type temperature detecting element which is not in contact with the surface of the canned product is used in the canned product heating apparatus. Therefore, the surface temperature of the canned product can be detected even if the outer diameter of the canned product to be heated is altered, or even if the positional relation between the canned product and the temperature detecting element is changed. Therefore, duration of heating the canned product can be determined on the basis of the detection result. In addition to the advantages, even if the noncontact-type temperature detecting element is thus used, the canned product can be prevented from being heated more than necessary so that the canned product will not be deformed or exploded as a result of such overheat of the canned product.

### BRIEF DESCRIPTION OF THE DRAWINGS

FIG. 1 is a side view showing an example of the canned product heating apparatus of the present invention.

FIG. 2 is a graph indicating a relation among a heating duration of the canned product, a deformation of the closure, and a temperature of the content of the canned product.

### BEST MODE FOR CARRYING OUT THE INVENTION

The present invention relates to a canned product heating apparatus, which is configured to heat the canned product when a consumer purchases the canned product being stored. Basically, liquid beverage such as coffee or tea is contained in the canned product, and in order to heat the content of the canned product homogeneously, it is preferable to oscillate or vibrate the canned product during heating the canned product. According to the present invention, the canned product heating apparatus is provided with a temperature sensor configured to detect a surface temperature of the canned product for the purpose of controlling the temperature of the canned product. Specifically, a nonconctact-type temperature detecting element is used to serve as the temperature sensor. Meanwhile, in order to heat the canned product without contacting thereto, it is preferable to use a high-frequency induction heating coil as the heating means. Therefore, the canned product heating apparatus is further provided with an electric circuit adapted to control the heating means. Specifically, an interrupting circuit configured to prevent an overheating of the canned product is used as the control means. In addition, the canned product heating apparatus according to the present invention is configured to prevent the canned product from being heated more than required. Therefore, the canned product heating apparatus is provided with a means for detecting a fact that the temperature of the canned product is raised to a predetermined temperature without detecting the surface temperature of the canned product. Specifically, the aforementioned means is configured to detect vibrations or sonic waves resulting form a deformation of the can lid of the canned product. The can lid of the canned product is fixed to a can trunk of the canned product at its circumference. Therefore, in case the temperature of the canned product is raised to the predetermined temperature, the can lid is deformed elastically by the inner pressure of the canned product raised by the temperature rise. As a result, the can lid of the canned product is vibrated like a behavior of a diaphragm. Therefore, the canned product heating apparatus of the present invention is configured to stop heating the canned product by detecting the vibrations or sonic waves of the can lid thus generated. For this purpose, according to the present invention, a highly directional microphone is used to detect the vibrations of the can lid of the canned product, and the canned product heating apparatus is configured to stop the heating means to heat the canned product based on the detection signal detected by the highly directional microphone.

### Example

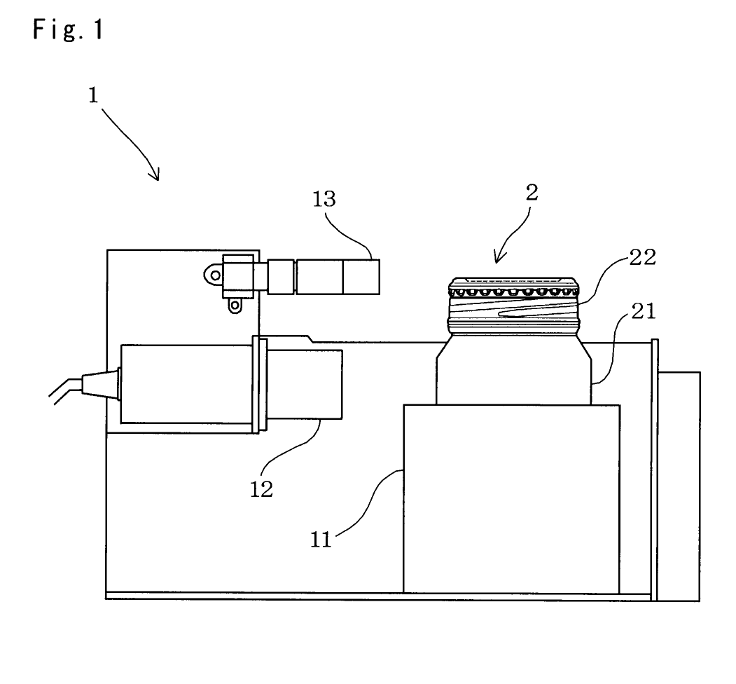

Here will be explained an example of the canned product heating apparatus 1 of the present invention. As shown in FIG. 1, the canned product heating apparatus 1 according to the example is configured to heat a threaded can container 2 containing beverage such as coffee therein. Specifically, the threaded can container 2 comprises: a cylindrical can trunk 21, which is formed by seeming a steel plate by a resistance welding method and reducing a diameter thereof at its opening end portion; a not shown bottom lid made of steel, which is fixed to a bottom end of the can trunk 21 by a double-seeming method; a threaded portion, which is formed on the opening end portion of the can trunk 21 at which the diameter thereof is reduced; and a closure 22 made of aluminum, which is applied to the threaded portion to serve as a cap. Therefore, the can container 2 can be opened by rotating the closure 22 thereby dismounting the closure 22 form the threaded portion. In addition, the can container 2 can be resealed by rotating the closure 22 in the counter direction thereby applying the closure 22 to the threaded portion. For this reason, a remaining beverage can be held in the can container 2 even after opening the can container 2.

Specifically, an outer diameter of the can container 2 is approximately 52 mm, and a diameter of the opening end side of the can trunk 21 is reduced and the threaded portion is formed thereon. Meanwhile, an outer diameter of the aluminum closure 22 to be applied to the threaded portion of the can container 2 is approximately 43 mm. Therefore, a total height of the can container 2 under the condition in which the closure 22 is being applied is approximately 103 mm. In addition, a shape of a top panel of the closure 22 is a flat circular shape. However, a center portion of the top panel of the closure 22 is slightly depressed to form a circular flat ceiling while leaving a ring having approximately 5 mm width on an outer circumferential edge of the flat top panel.

In this example, a beverage such as coffee of approximately 90 degrees C. is filed in the can container 2 in the amount of approximately 170 grams, and in this situation, air containing oxygen existing in a headspace is replaced by a steam of the beverage. Then, the closure 22 is applied to the opening end side of the can trunk 21 to close the can container 2 tightly. The temperature of the beverage thus contained in the can container 2 drops gradually to a room temperature. As a result, an internal pressure of the can container 2 is reduced to the range between −15 cmHg (−199.98 hPa) to −25 cmHg (−333.30 hPa). Thus, in this situation, the internal pressure of the can container 2 is a negative pressure.

As shown in FIG. 1, according to the canned product heating apparatus 1, a high-frequency induction heating coil 11 is arranged around the can container 2. Therefore, the content of the can container 2 is heated by heating the surface of the can trunk 21 by the high-frequency induction heating coil 11. In addition, the canned product heating apparatus 1 is provided with a temperature detecting element 12 for estimating a temperature of the content by detecting a surface temperature of the can container 2. For this purpose, the temperature detecting element 12 is arranged to be opposed to the can trunk 21. The canned product heating apparatus 1 is further provided with a directional microphone 13 configured to pick up a sound within the predetermined range of sonic waves. For this purpose, the directional microphone 13 is oriented to the closure 22 of the can container 2. Accordingly, the directional microphone 13 serves as the detecting means of the present invention.

More specifically, the temperature detecting element 12 is a noncontact-type temperature detecting element, which is configured to detect the surface temperature of the can container 2 without being contacted with the can container 2. Information of the surface temperature of the can container 2 (i.e., a detection signal) detected by the temperature detecting element 12 is transmitted to a temperature detecting circuit of a not shown control device for the purpose of controlling an electrical power distribution to the high-frequency induction heating coil 11 by the temperature detecting circuit.

The electric power distribution to the high-frequency induction heating coil 11 can be controlled flexibly by the control device in accordance with a heating procedure. For example, a length of required time to heat the can container 2 to raise the temperature of the beverage to a temperature appropriate to drink (e.g., 55 degrees C.) can be calculated in advance. In this case, the length of time to distribute the electric power to the high-frequency induction heating coil 11 is calculated on the basis of a detected initial surface temperature of the can container 2, and the electric power is distributed to the high-frequency induction heating coil 11 for the calculated length of time.

Alternatively, the electrical power distribution to the high-frequency induction heating coil 11 can also be controlled by detecting the temperature of the can container 2 during heating. In this case, the electrical distribution to the high-frequency induction heating coil 11 is stopped at the moment when the surface temperature of the can container 2 being heated is raised to the temperature at which the temperature of the beverage contained therein is assumed to be appropriate to drink. In addition, even in case of heating the can container 2 for the length of time calculated on the basis of the detected initial surface temperature thereof, the heating of the can container 2 can also be stopped when the surface temperature of the can container 2 is raised to the temperature at which the temperature of the beverage contained therein is assumed to be appropriate to drink.

However, as described, the non-contact type temperature detecting element 12 is configured to detect the surface temperature of the can container 2 without being contacted thereto. Therefore, the temperature detecting element 12 has a margin of a measuring error within a range of approximately plus or minus 6 degrees C. Specifically, the surface temperature of the can container 2 may be measured approximately 6 degrees C. lower than the actual temperature thereof. In this case, the can container 2 is to be heated on the basis of the temperature thus estimated 6 degrees C. lower than the actual temperature thereof. That is, the can container 2 is further heated until the actual surface temperature thereof is raised to approximately 6 degrees C. higher than the detected temperature. This means that the can container 2 is heated even after the temperature of the beverage contained therein exceeds the temperature appropriate to drink (e.g., 55 degrees C.).

In case the can container 2 is thus further heated even after the temperature of the beverage contained therein exceeds the temperature appropriate to drink, an internal pressure of the can container 2 is raised. As a result, the circular flat ceiling of the closure 22 formed inside of the outer ring is elastically expanded in its thickness direction. Specifically, the circular flat ceiling of the closure 22 depressed inwardly is popped up instantaneously or abruptly, and in this situation, the circular flat ceiling of the closure 22 is thereby vibrated while emitting a vibrating sound. The vibrating sound resulting from such a membrane oscillation of the circular flat ceiling of the closure 22 is called a “deformation noise”, and frequency of the deformation noise is within a range of 1 to 2 KHz. In addition, if the can container 2 is further heated even after the emission of the deformation noise, the circular flat ceiling of the closure 22 is deformed plastically, and eventually the closure 22 is ruptured. As a result, the beverage leaks from the can container 2.

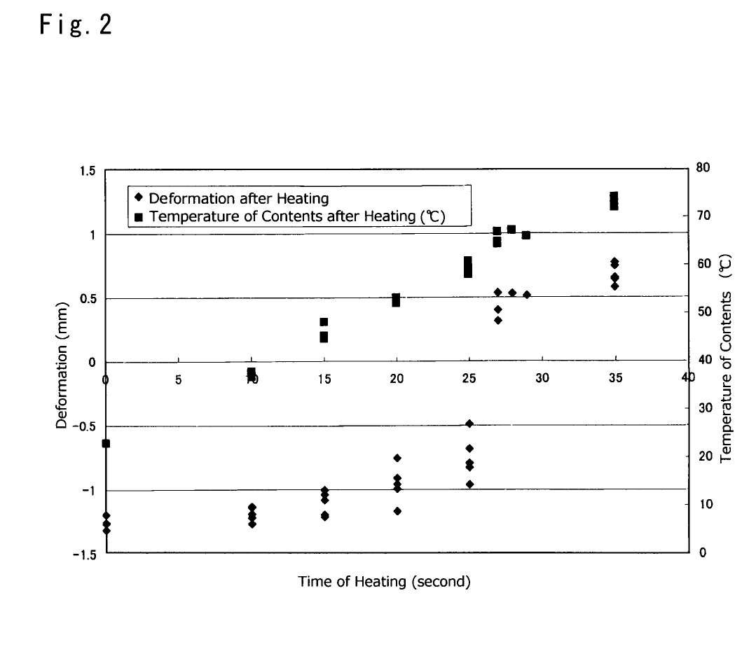

The situation of the can container 2 during the heating process will be explained in more detail. FIG. 2 is a graph indicating a measurement result of a relation among a heating duration of the can container 2, a deformation of (the circular flat ceiling of) the closure 22, and a temperature of the content of the can container 2. Specifically, in the measurement, a plurality of can containers 2 were heated by 1300 W using the high-frequency induction heating coil 11. Before a commencement of heating, the temperature of the beverage contained in the can container 2 was approximately 22 degrees C., and the internal pressure of the can container 2 was negative. In this situation, the circular flat ceiling of the closure 22 was situated approximately 1.3 mm lower than the top flat face of the aforementioned outer ring.

As indicated in FIG. 2, the temperature of the beverage was raised to approximately 55 degrees C. which is appropriate to drink after approximately 22 seconds from the commencement of hating the can container 2. Then, the can container 2 was further heated, and the temperature of the beverage was raised to approximately 65 degrees C. after approximately 27 seconds from the commencement of the heating. As a result, the internal pressure of the can container 2 was turned into a positive pressure, and the circular flat ceiling of the closure 22 was thereby expanded instantaneously to protrude outwardly about 0.5 mm while emitting the aforementioned deformation noise within the range of approximately 1 to 2 KHz frequency. Then, the can container 2 was further heated, and the beverage leaked from between the closure 22 and can trunk 21 after approximately 35 degrees C. from the commencement of the heating.

As described above, the deformation noise is emitted at an instant when the temperature of the beverage becomes approximately 65 degrees C., that is, before the beverage leaks from between the closure 22 and the can trunk 21, or before the closure 22 is blown off to uncap the can container 2. Therefore, according to the present invention, the canned product heating apparatus 1 is configured to stop heating the can container 2 utilizing the deformation noise. For this purpose, according to the example of the present invention, the canned product heating apparatus 1 is provided with: the directional microphone 13 which is oriented to the closure 22 to pick up the deformation noise of the can container 2; and an interrupting circuit (not shown) configured to interrupt electric power distribution to the high-frequency induction heating coil 11 when the directional microphone 13 captures the deformation noise within the range of approximately 1 to 2 KHz frequency under the condition in which the electric power is being distributed to the high-frequency induction heating coil 11.

As described above, the temperature detecting element 12 is configured to measure the surface temperature of the can container 2 without being contacted with the can container 2. Therefore, the surface temperature of the can container 2 measured by the temperature detecting element 12 may be lower than the actual temperature. Consequently, the can container 2 will be further heated even after the temperature of the beverage contained therein is raised to the desired drinkable temperature, and in this situation, the deformation noise is emitted before an occurrence of leakage of the beverage or explosion of the can container 2. However, according to the example, the canned product heating apparatus 1 is configured to pick up the deformation noise by the directional microphone 13, and to interrupt the electrical supply to the high-frequency inducting heating coil 11 as soon as a detection signal of the deformation noise is transmitted to the interrupting circuit. Therefore, according to the present invention, the closure 22 of the can container 2 can be prevented from being deformed more than necessary. For this reason, the can container 2 can be prevented from being exploded so that the contents contained therein will not leak from the can container 2.

According to the example of the present invention, the canned product heating apparatus 1 is structured as thus has been explained. However, the canned product heating apparatus 1 of the present invention should not be limited to the specific example thus far explained. For example, a canned product in which a closure is fixed to a can trunk by a double-seaming method can also be heated by the canned product heating apparatus 1, instead of the above explained threaded can container. In addition, in order to agitate the contents of the canned product thereby heating the contents homogeneously, the canned product heating apparatus 1 may also be configured to swing the canned product together with the high-frequency induction heating coil during the heating process. Thus, a configuration of the canned product heating apparatus of the present invention may be altered according to need.

1. A canned product heating apparatus, comprising:
a heating means, which is adapted to heat a content of a canned product by heating a surface of the canned product sealed by a closure;
a temperature detecting element, which is adapted to detect a temperature of the surface of the canned product; and
a control means, which is adapted to control the heating means to carry out a heating and to stop the heating in accordance with the temperature detected by the temperature detecting element, characterized in that:
the canned product heating apparatus further comprises a detecting means which is adapted to detect vibrations of the closure of the canned product during the heating of the canned product; and
the control means includes a means adapted to stop the heating means to heat the canned product, in case the detecting means detects particular vibrations of the closure resulting from temperature rise of the surface of the canned product.

2. The canned product heating apparatus, as claimed in claim 1, wherein:
the temperature detecting element is adapted to detect the temperature of the surface of the canned product without being contacted thereto;
the heating means includes a high-frequency induction heating coil;
the detecting means includes a directional microphone; and
the control means includes a interrupting circuit which is adapted to interrupt electrical power distribution to the high-frequency induction heating coil.

3. The canned product heating apparatus as claimed in 1, wherein the particular vibrations include sonic waves within a predetermined frequency range resulting from a deformation of the closure.

4. The canned product heating apparatus as claimed in claim 2, wherein the particular vibrations include sonic waves within a predetermined frequency range resulting from a deformation of the closure.
